(19) United States
(12) Patent Application Publication
(10) Pub. No.: US 2004/0078239 A1
(43) Pub. Date: Apr. 22, 2004

(54) Integrated patient care method, apparatus, and system

(76) Inventor: Victoria K. Dacosta, Santa Barbara, CA (US)

Correspondence Address: Brian C. Kunzler, Suite 450, 10 West 100 South, Salt Lake City, UT, 84101, US

(21) Appl. No.: 10/603,838

(22) Filed: Jun. 25, 2003

Related U.S. Application Data
(60) Provisional application No. 60/391,468, filed on Jun. 25, 2002.

(51) Int. Cl. G06F 17/60

(52) U.S. Cl. 705/3

(57) ABSTRACT

A method for tracking patient data allows practitioners to increase patient care effectiveness. The method includes providing a host computer for storing data thereon, transmitting the patient data to the host computer via a network, storing the patient data on the host computer, and providing access to the patient data via a client computer. In one embodiment, storing patient data includes storing a treatment plan for a patient. The method may also include tracking patient compliance with the treatment plan. In another aspect of the present invention, an apparatus for integrated patient care includes a patient module that displays a treatment plan on a client computer, a practitioner module that monitors the progress of the patient in following the treatment plan, and an office module that transmits billing statements for the treatment plan to an insurance carrier. The present invention facilitates increased patient contact with practitioners and increased treatment effectiveness.

### RELATED APPLICATIONS

This application claims priority to U.S. Provisional Patent Application Serial No. 60391468, filed on Jun. 25, 2002, entitled “Method and Apparatus for Dental Hygiene Tracking.”

### BACKGROUND OF THE INVENTION 1. The Field of the Invention

The invention relates to methods, devices, and systems for patient care. Specifically, the invention relates to methods, devices, and systems for integrating practitioner training, patient monitoring, and office procedures. 2. The Relevant Art

Medical and dental practitioners service patients through patient examinations and treatments. Typically patients visit medical or dental practitioners to seek help in relieving symptoms of diseases and ailments. Patients also visit practitioners to periodically monitor the health status of the patient. For example, a patient may receive a physical examination from a medical doctor or a bi-annual checkup and tooth cleaning from a dentist.

Providing examinations and treatments to patients requires a large amount of overhead. One form of overhead includes scheduling patient visits and patient follow-up visits. Another form of overhead includes billing patients for services rendered on behalf of the patient. In general, a secretary or the like records patient appointments in a software program stored on a computer system. In most instances, secretaries also use software to produce and print billing statements. While useful, these software programs require secretaries to spend much of their time scheduling appointments, sending follow-up reminders to patients, and preparing insurance forms.

In addition to the overhead of running a medical or dental office, practitioners generally have little or no contact with patients between appointments. However, increased practitioner contact with the patient is desirable. For instance, treatments that require patients to follow a strict patient treatment plan could be more effective if practitioners monitored the patient's progress between appointments.

Practitioner treatments also increase in effectiveness as practitioners continue to receive training and information regarding new, innovative products and treatment methods. Currently available practitioner reference programs contain reference material such as disease descriptions and treatment methods. However, these reference programs do not provide practitioner training or discussion forums for practitioners.

Examples of prior patents in the general area of patient management are outlined below. Each of these references is incorporated by reference for its supporting teachings. This application hereby incorporates the following United States patents by reference: U.S. Pat. No. 5,923,018, U.S. Pat. No. 6,345,260B1, U.S. Pat. No. 6,148,297, U.S. Pat. No. 5,579,393, U.S. Pat. No. 5,327,341, and U.S. Pat. No. 5,752,827.

Each of these prior art references disclose improvements in the area of patient management. However, none of the foregoing patents have adequately addressed the inherent challenges of integrating a management system for patient care.

What is needed are methods, devices, and systems for integrating patient treatments, practitioner training, and office management. In particular what is needed are methods, devices, and systems for increasing the effectiveness of patient care, reducing office overhead, and increasing practitioner training and competency.

### SUMMARY OF THE INVENTION

The various elements of the present invention have been developed in response to the present state of the art, and in particular, in response to the problems and needs in the art that have not yet been fully solved by currently available patient care devices, methods, and systems. Accordingly, the present invention provides an improved method, apparatus, and system for integrated patient care.

In one aspect of the present invention, a method for tracking patient data includes providing a host computer for storing patient data thereon, transmitting the patient data to the host computer via a network, which is operably connected to the host computer, storing the patient data on the host computer, and providing access to the patient data via a client computer, which is operably connected to the network, in response to receiving a request from a practitioner. The method of the present invention provides increased contact between patients and practitioners.

In one embodiment, storing patient data includes storing a medical history of a patient, which may include previous patient treatments, medications, allergies, and the like. Storing patient data may also include storing preferences of the patient, such as a preferred amount of anesthetic to be used before an operation and types of holistic remedies that the patient prefers. By storing medical and preferential data for the patient, the method creates an awareness of the patient that leads to augmented treatment experiences for the patient.

In another embodiment, storing patient data also includes storing a treatment plan for a patient. The method may also include tracking compliance of the patient with the treatment plan. Consequently, the method of the present invention provides increased practitioner awareness of patient adherence to a treatment plan.

Storing patient data may further include storing patient data in response to examining the patient or in response to treating the patient. Patient data that is stored in response to patient examination or treatment provides a record for practitioners to predict and diagnose potential future patient problems.

Yet in another embodiment, the method further includes transmitting billing statements to an insurance carrier over the network. The transmitted billing statements correspond to fees for care given to the patient. In addition, another embodiment also includes automatically generating and transmitting the billing statements in response to inputting billing codes to the host computer.

In another embodiment, receiving a request from the practitioner also includes receiving an access code from the practitioner. In one embodiment, the access code is provided to the practitioner by the patient. Patients consequently have privacy over their patient data and can selectively allow practitioners to access the patient data.

In another aspect of the present invention, an apparatus for integrated patient care includes a patient module that displays a treatment plan on a client computer and receives input from a patient corresponding to progress of the patient in following the treatment plan, a practitioner module that monitors the progress of the patient in following the treatment plan, and an office module that transmits billing statements corresponding to the treatment plan to an insurance carrier.

Additionally, in another embodiment, the patient module also receives input from the patient corresponding to the patient's preferences. In another embodiment, the patient module also provides reference data to the patient. The patient is thus able to learn about various medical treatments, medications, and the like.

Furthermore, another aspect is for the practitioner module to provide interactive training to a practitioner. The practitioner module may also include practitioner organization tools and reference tools. Consequently, the practitioner module provides integrated tools to increase the practitioner's productivity and skills.

In another embodiment, the office module orders products in response to observing reduced inventory. The office module may also generate reports in response to receiving patient data. The office module provides automation to normal office routines, reducing overhead expenses for the practitioner.

Various elements of the present invention are combined into a system for integrated patient care. The system for integrated patient care includes at least one client computer, a host computer operably connected to the client computer via a network, a database residing on the host computer, a patient module, a practitioner module, and an office module.

The patient module of the integrated care system receives a treatment plan from the database, displays the treatment plan on the client computer, and stores input from a patient corresponding to progress of the patient in following the treatment plan in the database. The practitioner module monitors the progress of the patient in following the treatment plan and stores data corresponding to the progress of the patient in the database, and the office module transmits billing statements corresponding to the treatment plan to an insurance carrier.

The various elements and aspects of the present invention provide an integrated care experience for patients and practitioners. Consequently, the present invention increases effectiveness of patient treatments, reduces office overhead, and increases practitioner awareness of patient problems.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention. These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the advantages of the invention are obtained will be readily understood, a more particular description of the invention briefly described above will be rendered by reference to specific embodiments thereof, which are illustrated in the appended drawings. It is noted that like numbering between and within each of the figures are intended to represent the same elements between the figures as is customary in the art. Understanding that these drawings depict only typical embodiments of the invention and are not therefore to be considered to be limiting of its scope, the invention will be described and explained with additional specificity and detail through the use of the accompanying drawings in which:

FIG. 1 is a schematic block diagram illustrating one embodiment of an integrated patient care system of the present invention;

FIG. 2 is a schematic block diagram illustrating an additional embodiment of an integrated patient care of the present invention;

FIG. 3 is a block diagram illustrating one embodiment of a database of the present invention;

FIG. 4 is a flow chart diagram illustrating one embodiment of an integrated care method of the present invention; and

FIG. 5 is a representative illustration of a patient tracking screen.

### DETAILED DESCRIPTION OF THE INVENTION

Many of the functional units described in this specification have been labeled as modules, in order to more particularly emphasize their implementation independence. For example, modules may be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module. For example, a module of executable code could be a single instruction, or many instructions, and may even be distributed over several different code segments, among different programs, and across several memory devices.

Modules may also be implemented in hardware as electronic circuits comprising custom VLSI circuitry, off-the-shelf semiconductors such as logic chips, transistors, or other discrete components. A module may also be implemented in programmable hardware devices such as field programmable gate arrays, programmable array logic, programmable logic devices or the like.

Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

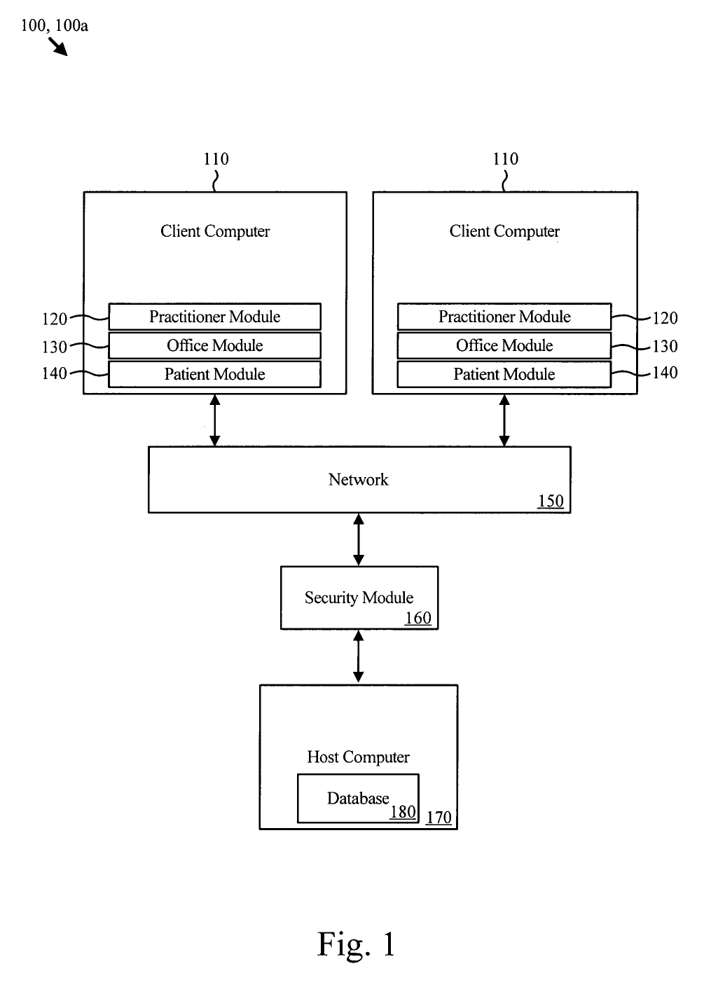

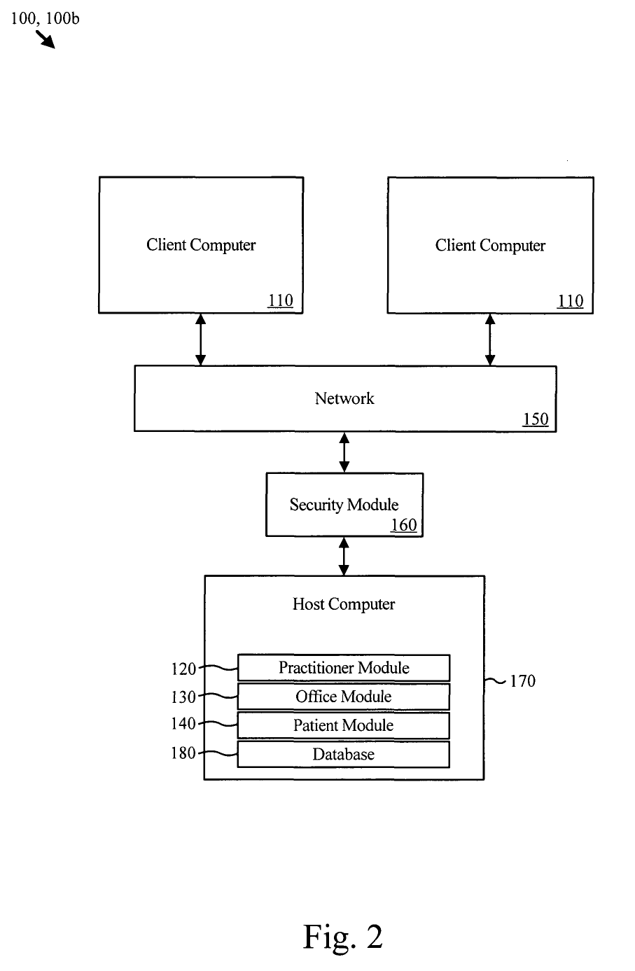

Referring now to FIGS. 1 and 2, there are schematic block diagrams illustrating selected embodiments of an integrated patient care system 100 of the present invention. The depicted embodiments of the integrated patient care system 100 include client computers 110, practitioner modules 120, office modules 130, patient modules 140, a network 150, a security module 160, a host computer 170, and a database 180. The integrated patient care system 100 increases the effectiveness of practitioners, such as medical or dental practitioners, in providing and monitoring patient treatments.

FIG. 1 depicts a particular embodiment of the integrated patient care system 100, wherein the practitioner module 120, office module 130, and patient module 140 reside on the client computers 110. Likewise, FIG. 2 depicts a particular embodiment of the integrated patient care system 100, wherein the practitioner module 120, office module 130, and patient module 140 reside on the host computer 170.

In one embodiment, the client computers 110 are desktop computers, laptop computers, tablet Personal Computers (tablet PCs), Personal Digital Assistants (PDAs), pocket Personal Computers (pocket PCs), or the like. In one embodiment, the client computer 110 is a chair-side computer located in a practitioner's office. In another embodiment, the client computer 110 is a patient computer located in a patient's home.

In the depicted illustrations, one or more client computers 110 are operably connected to the host computer 170 via the network 150. In one embodiment, the network 150 is a global network such as the Internet, connecting numerous practitioners and patients via several client computers 110. In another embodiment, the network 150 is a local area network (LAN) or a wide area network (WAN), also connecting multiple client computers 110.

Practitioners, such as medical practitioners, dental practitioners, and the like can use the client computers 110 to perform several tasks that facilitate efficient, improved care of patients. In addition, patients can use the client computers 110 to learn more about medical procedures and provide feedback to practitioners.

The aforementioned tasks are accomplished in part by use of the practitioner module 120, the office module 130, and the patient module 140. Each module may receive input from a user and transmit commands corresponding to the input to the host computer 170 via the network 150. In one embodiment, users include patients, office staff, medical practitioners, dental practitioners, and the like.

In certain embodiments, the practitioner module 120, the office module 130, and the patient module 140 include one or more screens displayed as graphical user interfaces (GUI) on the client computers 110, whereby users can input and retrieve data. For example, the GUIs may include one or more web pages viewable on a standard World Wide Web browser, or may include program code that functions independent of a World Wide Web browser.

The practitioner module 120 may also includes personal organizer tools. Through one or more screens on the client computer 110, a practitioner may use the personal organizer tools to create appointments, view existing appointments and view contact information of patients and other practitioners. Additionally, the practitioner may add, change, or view personal and business goals.

The practitioner module 120 may also include communication tools. Communication tools may include an electronic mail program, a network navigation program such as a World Wide Web browser, web conferencing programs, and the like. Through one or more screens displayed on the client computer 110, a practitioner may use the communication tools to discuss patient treatment methods with other practitioners, exchange ideas related to improving business methods, and receive training from practitioner coaches.

Additionally, the practitioner module 120 may be able to include reference tools viewable on one or more screens displayed on the client computer 110. Through one or more screens displayed on the client computer 110, a practitioner may access disease information, treatment information, symptom information, diagnostic descriptions, descriptions of diagnostic procedures, descriptions of medical procedures, medical equipment descriptions, descriptions of patient care procedures, government regulation information, frequently asked questions (FAQs) and corresponding answers, and the like. The reference material may exist in electronic book format, web page format, or the like.

It is also contemplated for the practitioner module 120 to potentially include tracking tools for monitoring a patient's compliance with a treatment plan. The tracking tools include one or more screens displayed on the client computer 110 that describe various steps a patient has taken in complying with a treatment plan. In one embodiment, the tracking tools also display graphs, charts, and figures corresponding to patient health improvements. For instance, in one embodiment a periodontal chart displays gum pocket measurements over a period of time. In addition, the practitioner module 120 also includes screens that provide access to patient medical and dental histories, patient billing histories, and the like.

The various personal organizer tools, communication tools, reference tools, and tracking tools of the practitioner module 120 utilize the database 180 for storing and retrieving data. In addition, the security module 160 prevents unauthorized access to the data stored in the database 180. Consequently, only authorized personnel, like practitioners or support staff, have access to the data in the database corresponding to the practitioner module 120.

Referring now to the office module 130, there may be provided screens displayed on the client computer 110 that increase automation of business methods associated with running a medical or dental practice. In one embodiment, the office module 130 includes an ordering tool. The ordering tool monitors an inventory of office supplies and medical or dental supplies. In addition, the ordering tool orders products from office or medical supplies in response to observing reduced inventory.

The office module 130 may also include insurance tools for automating insurance billing processes. For example, a practitioner may input medical procedures performed on behalf of a patient into the insurance tool. The insurance tools calculates relative value units (RVU) corresponding to the medical procedures and generates a billing statement. Another example is where the insurance tools send an electronic billing statement to an insurance carrier in response to generating a billing statement.

The office module 130 may also include report tools for generating office reports. The report tool generates graphs, charts, and spreadsheets in response to receiving patient data, office data, or the like from the database 180. A practitioner may configure the report tool to generate financial reports, patient progress reports, and the like.

The ordering tools, insurance tools, and report tools of the office module 130 also utilize the database 180 for storing and retrieving data. In addition, the security module 160 prevents unauthorized access to the data stored in the database 180. Consequently, only authorized users have access to the data in the database corresponding to the office module 130.

Referring now to the patient module 140, there may be provided screens displayed on the client computer 110 that enable patients to learn more about medical procedures and provide feedback to practitioners. The patient module 140 may include reference tools that describe medical terminology, medical procedures, and the like. The patient module 140 may also provide treatment plan tracking tools. The treatment plan tracking tools include one or more screens detailing recent patient treatments, recommended techniques for increasing the effectiveness of the treatments, and a treatment scheduler. Through the treatment scheduler, patients are able to use tables, spreadsheets, or the like to input patient progress in following a treatment plan. Through the tracking tools in the practitioner module 120, a practitioner may observe the progress entered by the patient in the patient module 140.

The patient module 140 is also contemplated to potentially include patient preference tools, which allow patients to inform practitioners of their treatment preferences. For example, in one embodiment a patient may indicate through screens provided by the preference tools that the patient desires at least two shots of novocain during dental procedures. The patient may also indicate through the preference tools various holistic methods that ease the patient's mind during medical or dental procedures. Furthermore, through the patient preference tools, the patient may provide feedback to practitioners regarding the patient's medical or dental experience.

The reference tools and patient preference tools of the patient module 130 utilize the database 180 for storing and retrieving data. In addition, the security module 160 prevents unauthorized access to the data stored in the database 180. Consequently, only authorized patients and practitioners have access to the data in the database corresponding to the patient module 140.

Referring now to the security module 160, this module has the function of facilitating secure communication between client computers 110 and the host computer 170. While the security module 160 is depicted as being operably connected to the network 150 and the host computer 170, the security module may also reside on the host computer 170. In addition, the security module 160 may include firewalls, encrypted files, password protected files, or the like. In one embodiment, the security module 160 prevents unauthorized access to patient, office, and practitioner data stored in the database 180. In another embodiment, the security module 160 provides practitioners with access to patient data in response to receiving an access code from a patient.

It is noted that the various elements of the integrated care system 100 of the present invention increase the effectiveness of patient treatment by tracking patient compliance with treatment plans, increasing interactions among patients and practitioners, and training practitioners through conferencing and various reference materials. In addition, improved product ordering and billing procedures increase the efficiency of practitioners and reduce overhead associated with running a medical or dental practice.

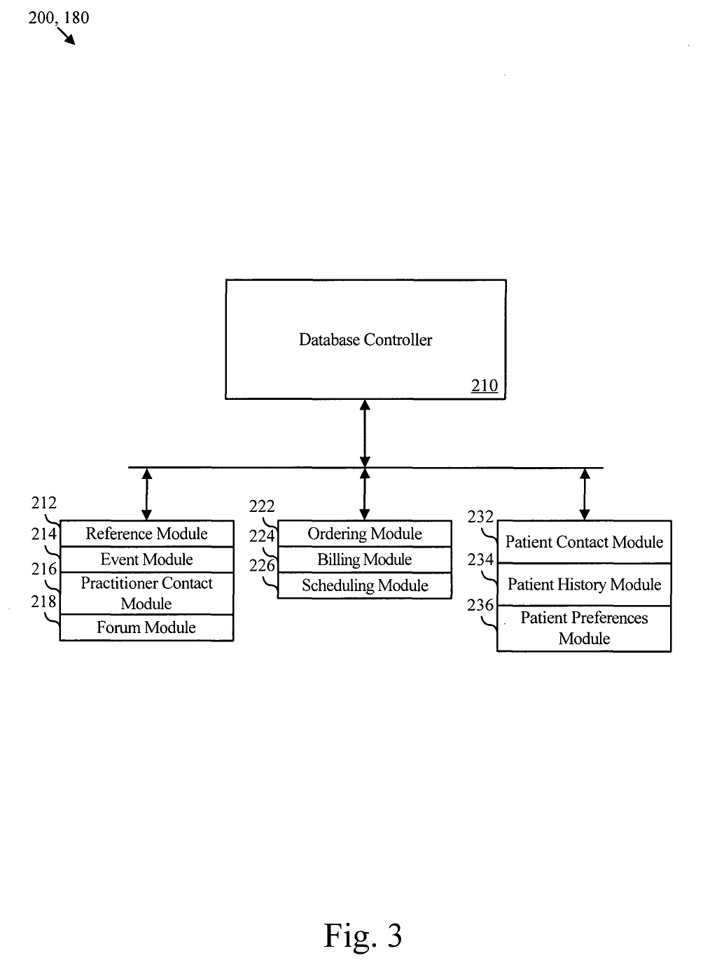

FIG. 3 is a block diagram illustrating one embodiment of a database 180 of the present invention. The depicted embodiment includes a database controller 210, a reference module 212, an event module 214, a practitioner contact module 216, a forum module 218, an ordering module 222, a billing module 224, a scheduling module 226, a patient contact module 232, a patient history module 234, and a patient preferences module 236. It is contemplated for the database 180 to potentially be located on one or more storage devices (not shown), or on the host computer 170 as illustrated in FIGS. 1 and 2.

In the depicted embodiment of the database 180, the database controller 210 receives commands from the host computer 170 and executes corresponding database operations on the data stored in the database 180. The database controller 210 facilitates recording and retrieving practitioner, office, and patient information from the database 180.

The reference module 212 may include reference data such as disease information, treatment information, symptom information, diagnostic descriptions, descriptions of diagnostic procedures, descriptions of medical procedures, medical equipment descriptions, descriptions of patient care procedures, government regulation information, frequently asked questions (FAQs) and corresponding answers, and the like.

Referring to the event module 214, it may contain practitioner event schedules, such as web conference schedules, patient treatment plan tracking schedules, and the like. The event module 214 may also contain practitioner goals for improved practitioner performance. By storing events in the event module 214, practitioners around the world can coordinate training events.

The practitioner contact module 216 is designed to contain contact information for various practitioners. In one embodiment, contact information includes addresses, phone numbers, email addresses, web sites, and the like. The forum module 218 includes augmented reference material for practitioners. In certain embodiments, the augmented reference material includes web conference transcripts, lecture transcripts, training session transcripts, FAQs, and the like.

The ordering module 222 may contain product inventories, vendor contact information, and product information. In addition, the billing module 224 contains patient billing information. In one embodiment, billing information includes insurance company contact information, insurance forms, relative value units (RVU) for dental or medical procedures, and the like.

The scheduling module 226 is designed to potentially contain patient schedules, including treatment schedules and the like. The patient contact module 232 contains patient contact info, such as address, telephone numbers, and the like.

The patient history module 234 may contain a history of medical procedures performed on patients, medicines prescribed for patients, patient allergies, patient treatment plan data, and the like. In one embodiment, the patient history module 234 contains gum and teeth status of a patient and a periodontal maintenance record of the patient.

The patient preferences module 236 is designed to store or process information related to patient preferences for different treatments. In one embodiment, the patient preferences module also contains patient preferences for different holistic treatments, such as aroma therapy and the like. It is contemplated to have a patient preference module to include a patient's desire to receive a specific amount of anesthetic before a medical procedure.

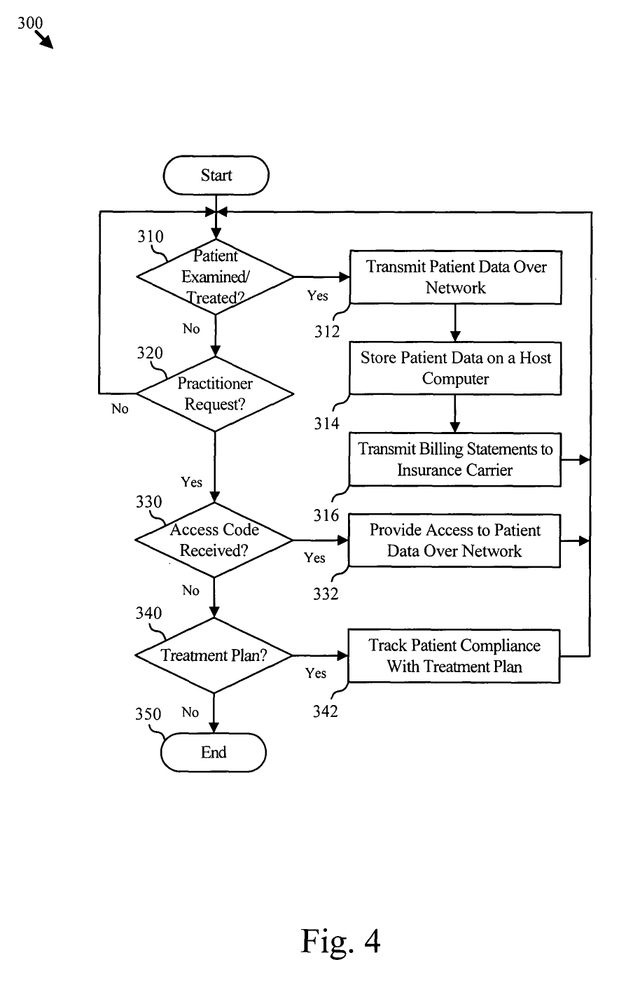

Turning now to FIG. 4, there is illustrated a flow chart diagram illustrating one embodiment of an integrated care method 300 of the present invention. The depicted embodiment of the integrated care method of the present invention includes a patient examined/treated test or step 310, a transmit patient data over a network step 312, a store patient data on a host computer step 314, a transmit billing statements to an insurance carrier step 316, a practitioner request step 320, an access code received step 330, a provided access to patient data over the network step 332, a treatment plan test 340, a track patient compliance with treatment plan step 342, and an end step 350.

The method begins by determining whether the patient was examined or treated 310. In response to determining that the patient was examined or treated 310, the method proceeds to the transmit patient data over a network step 312. The method then proceeds to the store patient data on a host computer 170 in step 314, followed by a transmit billing statements to an insurance carrier step 316. Thereafter, the method loops back to the patient examined/treated step 310.

In response to determining that the patient was not examined or treated 310, the method proceeds to the practitioner request 320, where it is determined whether a practitioner has requested 320 patient data. In response to not requesting data, the method loops back to the patient examined/treated step 310.

In response to determining that the practitioner did request data in step 320, the method proceeds to the access code received step 330, where the method determines whether a patient has given the practitioner a personal access code to view the patient's data. The method proceeds to the provide access to patient data over the network step 332 in response to receiving an access code from the patient and thereafter loops back to the patient examined/treated step or test 310. However, in response to not receiving an access code from the patient 330, the method proceeds to the treatment plan test 340. In the treatment plan test 340, the method determines whether a patient has received a treatment plan. The method then proceeds to the track patient compliance with the treatment plan step 342 in response to the patient receiving a treatment plan and thereafter loops back to the patient examined/treated test 310. The method proceeds to the end step 350 in response to the patient not receiving a treatment plan.

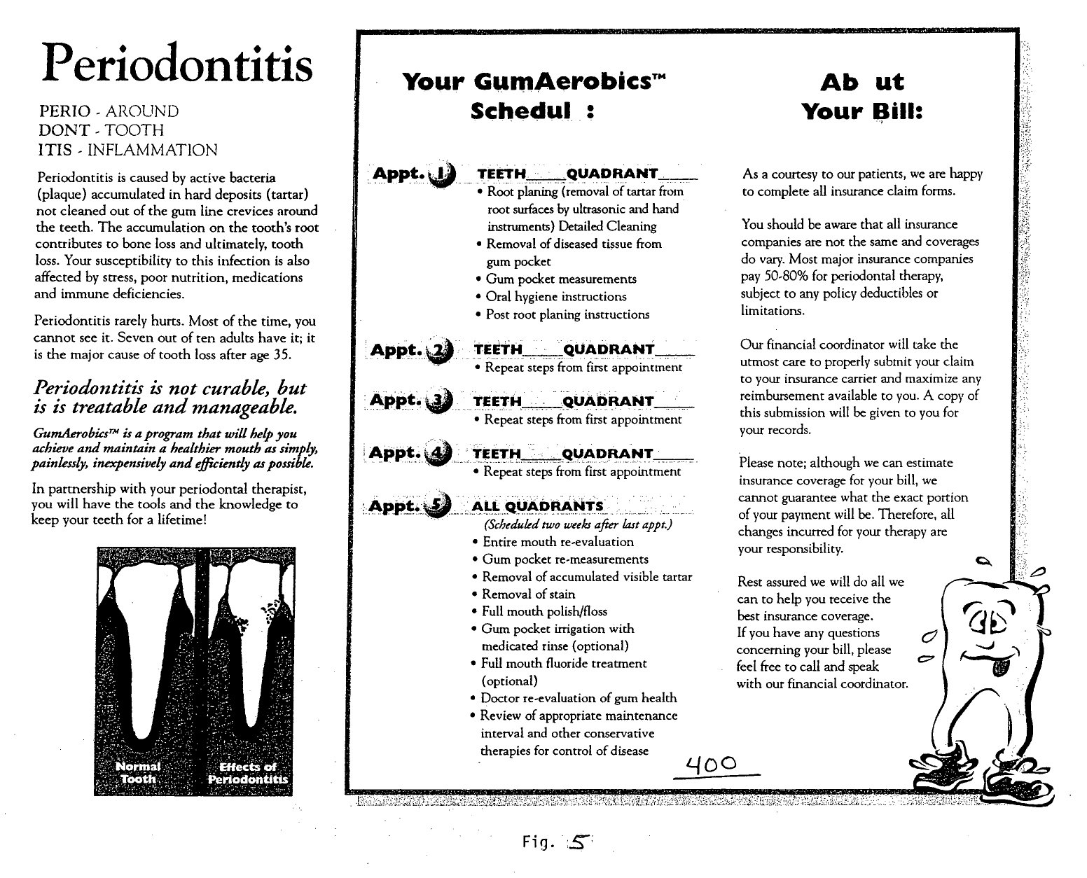

FIG. 5 is a text-based diagram illustrating one embodiment of a patient tracking screen 400 of the present invention. In the depicted embodiment of a patient tracking screen 400, a particular disease such as periodontitis is described, a treatment plan is described, and billing procedures are described. In one embodiment, a patient may use the patient tracking screen 400 to monitor the patient's progress in following the treatment plan.

The present invention increases the integration of practitioner information, office procedures, and patient information over the currently available art. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for tracking patient data, the method comprising:
providing a host computer for storing patient data thereon;
transmitting the patient data to the host computer via a network, which is operably connected to the host computer;
storing the patient data on the host computer; and
providing access to the patient data via a client computer, which is operably connected to the network, in response to receiving a request from a practitioner.

2. The method of claim 1, wherein storing patient data comprises storing a medical history of a patient.

3. The method of claim 1, wherein storing patient data comprises storing preferences of the patient.

4. The method of claim 1, wherein storing patient data comprises storing a treatment plan for a patient.

5. The method of claim 3, further comprising tracking patient compliance with the treatment plan.

6. The method of claim 1, wherein storing patient data further comprises storing patient data in response to examining a patient.

7. The method of claim 1, wherein storing patient data further comprises storing patient data in response to treating a patient.

8. The method of claim 1, further comprising transmitting billing statements to an insurance carrier over the network, wherein the billing statements correspond to fees for care given to a patient.

9. The method of claim 6, further comprising automatically generating and transmitting the billing statements in response to inputting billing codes to the host computer.

10. The method of claim 1, wherein receiving a request from the practitioner further comprises receiving an access code from the practitioner, wherein the access code is provided to the practitioner by a patient.

11. An apparatus for integrated patient care, the apparatus comprising:
a patient module configured to display a treatment plan on a client computer and receive input from a patient corresponding to progress of the patient in following the treatment plan;
a practitioner module configured to monitor the progress of the patient in following the treatment plan; and
an office module configured to transmit billing statements corresponding to the treatment plan to an insurance carrier.

12. The apparatus of claim 11, wherein the patient module is further configured to receive input from the patient corresponding to patient preferences.

13. The apparatus of claim 11, wherein the patient module is further configured to provide reference data to the patient.

14. The apparatus of claim 11, wherein the practitioner module is further configured to provide interactive training to a practitioner.

15. The apparatus of claim 11, wherein the practitioner module further comprises practitioner organization tools.

16. The apparatus of claim 11, wherein the practitioner module further comprises reference tools.

17. The apparatus of claim 11, wherein the office module is further configured to order products in response to observing reduced inventory.

18. The apparatus of claim 11, wherein the office module is further configured to generate reports in response to receiving patient data.

19. A system for integrated patient care, the system comprising:
at least one client computer;
a host computer, operably connected to the at least one client computer via a network;
a database residing on the host computer;
a patient module configured to receive a treatment plan from the database, display the treatment plan on the at least one client computer, and store input from a patient corresponding to progress of the patient in following the treatment plan in the database;
a practitioner module configured to monitor the progress of the patient in following the treatment plan and store data corresponding to the progress of the patient in the database, and is further configured to provide interactive training to a practitioner; and
an office module configured to transmit billing statements corresponding to the treatment plan to an insurance carrier, and is further configured to order products in response to observing reduced inventory.

20. The apparatus of claim 19, wherein the office module is further configured to generate reports in response to receiving patient data.
